(19) United States
(12) Patent Application Publication
(10) Pub. No.: US 2024/0297721 A1
(43) Pub. Date: Sep. 5, 2024

(54) ROBUST POLARIZATION-ENTANGLED QUANTUM SOURCE FROM ATOMIC ENSEMBLE AND IMPLEMENTATION METHODS

(71) Applicant: PUSAN NATIONAL UNIVERSITY INDUSTRY-UNIVERSITY COOPERATION FOUNDATION, Busan (KR)

(72) Inventors: Han-Seb MOON, Busan (KR); Heon Oh KIM, Ulsan (KR); Jiho PARK, Busan (KR); Jinhyuk BAE, Busan (KR)

(21) Appl. No.: 17/768,478

(22) PCT Filed: Dec. 31, 2021
(86) PCT No.: PCT/KR2021/020369

§ 371 Date: Apr. 13, 2022

(30) Foreign Application Priority Data
Nov. 2, 2021 (KR) 10-2021-0148914

(51) Int. Cl. H04B 10/70; G02F 1/35; G02F 1/355; H01S 3/091; H01S 3/10

(52) U.S. Cl. CPC H04B 10/70; G02F 1/3515; G02F 1/355; H01S 3/091; H01S 3/10061

(57) ABSTRACT

Disclosed are a robust polarization-entangled quantum source from an atomic ensemble and an implementation method. A robust polarization-entangled quantum source from an atomic ensemble according to an example embodiment includes an atomic vapor cell containing rubidium (⁸⁷Rb) atoms, and a processor configured to generate a photon pair of a signal and an idler from the atomic vapor cell by traveling a coupling laser and a pump laser in opposite directions with respect to the atomic vapor cell.

### TECHNICAL FIELD

The following description relates to a robust polarization-entangled quantum source from an atomic ensemble and an implementation method of implementing a bright and powerful polarization-entangled photon pair source by utilizing strong signal-idler polarization correlation using an atomic vapor cell.

### BACKGROUND ART

Implementation of a robust quantum entanglement source is a key technology for realizing quantum information science technology.

Implementing generation of quantum-entangled photon pairs is an important technology used in quantum communication, quantum cryptographic communication, and quantum information processing.

In particular, the implementation of generation of quantum-entangled photon pairs enables application to nodes of quantum information processing and quantum information networks including quantum memories when photons can interact with atoms.

Accordingly, the implementation of generation of quantum-entangled photon pairs requires photons with an intrinsic wavelength and linewidth of atoms.

A pair of entangled photons generated from an atomic ensemble has a very good advantage because the photons have the conditions to interact with atoms.

And, polarization entanglement using polarization characteristics of photons is a widely used entanglement state because an analysis and manipulation method of its polarization state is very reliable and effective.

A polarization-entangled photon pair generated in a spontaneous parametric down conversion (SPDC) process using a nonlinear crystal according to a related art has a photon linewidth that is too broad to interact with atoms.

Studies on the generation of polarization-entangled photon pairs using the atomic ensemble may include, for example, a method of implementation using a cooled atomic ensemble.

In this case, a generated photon pair is characterized in that the linewidth is narrow, but a very complicated device is required and the number of generated photon pairs is small.

In order to implement a polarization-entangled photon pair for realizing photon-based quantum communication and quantum information, it is necessary to implement a polarization entanglement state by superimposing a pair of photons correlated with high-efficiency, high-quality polarization generated in the atomic ensemble.

Further, since the quantum state changes according to a phase change between the photons in the process of overlapping the photon pair, there is a limitation that external vibration and environmental control are required to implement a stable quantum entanglement state.

Therefore, there is a pressing need to develop an improved model that implements a robust polarization-entangled quantum source generated from a warm atomic ensemble with a simple structure.

### DISCLOSURE OF THE INVENTION

### Technical Goals

An aspect provides a robust polarization-entangled quantum source from an atomic ensemble and an implementation method of implementing a bright and powerful polarization-entangled photon pair source by utilizing strong signal-idler polarization correlation using an atomic vapor cell.

Another aspect provides a robust polarization-entangled quantum source from an atomic ensemble and an implementation method of securing frequency stability with a precision corresponding to an atomic transition line and strongly generating all four Bell states with very high stability by applying an intrinsic polarization correlation generated from a ladder-type atomic system without using an interferometric configuration.

Yet another aspect provides a robust polarization-entangled quantum source from an atomic ensemble and an implementation method of enabling development of a polarization-entangled photon pair source with a high production rate using a low pump power.

### Technical Solutions

According to an aspect, there is provided a robust polarization-entangled quantum source from an atomic ensemble including an atomic vapor cell containing rubidium (⁸⁷Rb) atoms, and a processor configured to generate a photon pair of a signal and an idler from the atomic vapor cell by traveling a coupling laser and a pump laser in opposite directions with respect to the atomic vapor cell.

According to another aspect, there is provided an implementation method of a robust polarization-entangled quantum source from an atomic ensemble including preparing an atomic vapor cell containing rubidium (⁸⁷Rb) atoms, and generating a photon pair of a signal and an idler from the atomic vapor cell by traveling a coupling laser and a pump laser in opposite directions with respect to the atomic vapor cell.

### Advantageous Effects

According to an example embodiment, it is possible to provide a robust polarization-entangled quantum source from an atomic ensemble and an implementation method of implementing a bright and powerful polarization-entangled photon pair source by utilizing strong signal-idler polarization correlation using an atomic vapor cell.

Further, according to an example embodiment, it is possible to provide a robust polarization-entangled quantum source from an atomic ensemble and an implementation method of securing frequency stability with a precision corresponding to an atomic transition line and strongly generating all four Bell states with very high stability by applying an intrinsic polarization correlation generated from a ladder-type atomic system without using an interferometric configuration.

Furthermore, according to an example embodiment, it is possible to provide a robust polarization-entangled quantum source from an atomic ensemble and an implementation method of enabling development of a polarization-entangled photon pair source with a high production rate using a low pump power.

### BRIEF DESCRIPTION OF DRAWINGS

FIG. 1 is a block diagram illustrating a configuration of a robust polarization-entangled quantum source from an atomic ensemble according to an example embodiment.

FIG. 2a and FIG. 2b is a diagram for explaining generation of spontaneous four wave mixing (sFWM) in a trapezoidal atomic composition.

FIG. 3a and FIG. 3b is a diagram illustrating temporal statistical characteristic spectrum for two polarization entanglement modes.

FIG. 4a and FIG. 4b is a diagram illustrating evaluation of classicality violation of /ψ⁺> which is one of the maximum entangled states (Bell states).

FIG. Sa to FIG. 5d is a diagram illustrating results of reconstruction of a polarization density matrix through quantum-state tomography for four Bell states.

FIG. 6a to FIG. 6d is a diagram illustrating stability of a polarization-entangled photon pair.

FIG. 7 is a flowchart illustrating a method of implementing a robust polarization-entangled quantum source from an atomic ensemble according to an example embodiment.

### BEST MODE FOR CARRYING OUT THE INVENTION

Hereinafter, example embodiments will be described in detail with reference to the accompanying drawings. However, since various changes may be made to example embodiments, the scope of the patent application is not limited or restricted by these example embodiments. It should be understood that all changes, equivalents, and substitutes for the example embodiments are included in the scope of rights.

The terms used in the example embodiments are used for the purpose of description only, and should not be construed as limiting. A singular expression includes a plural expression unless clearly indicated otherwise in the context. It is to be understood that terms such as “comprise” or “have” in this specification are intended to specify the presence of the described features, numbers, steps, operations, components, parts, or combinations thereof, but not to preclude the possibility of the presence or addition of one or more other features, numbers, steps, operations, components, parts, or combinations thereof.

Unless defined otherwise, all terms used herein including technical or scientific terms have the same meaning as commonly understood by a person skilled in the art to which the example embodiments pertain. Terms such as those defined in dictionaries commonly used should be construed as having meanings consistent with the meanings in the context of the related art, and are not construed in ideal or excessively formal meanings unless explicitly defined herein.

Further, in the description with reference to the accompanying drawings, the same elements are given the same reference numeral regardless of numerals in the drawings, and overlapping description thereof will be omitted. In describing the example embodiments, in the case that it is determined that detailed descriptions of a related known art may unnecessarily obscure the gist of the example embodiments, the detailed descriptions thereof will be omitted.

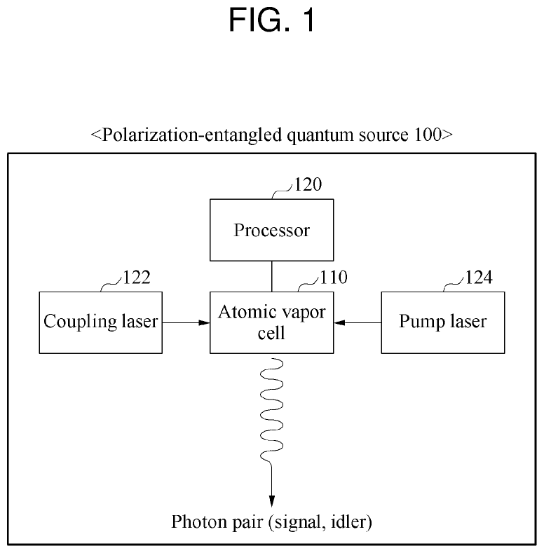

FIG. 1 is a block diagram illustrating a configuration of a robust polarization-entangled quantum source from an atomic ensemble according to an example embodiment.

Referring to FIG. 1, a robust polarization-entangled quantum source 100 from an atomic ensemble according to an example embodiment (hereinafter, abbreviated as ‘polarization-entangled quantum source’) may be configured to include an atomic vapor cell 110 and a processor 120 including a coupling laser 122 and a pump laser 124. Further, according to an example embodiment, the polarization-entangled quantum source 100 may be configured by selectively adding a prism mirror, a single photon detector, a ½λ-phase delay plate and a ¼λ-phase delay plate, and a polarizer for photon pair detection and verification.

First, the atomic vapor cell 110 contains rubidium (⁸⁷Rb) atoms. In other words, the atomic vapor cell 110 may serve to seal and maintain a gas of rubidium atoms.

The atomic vapor cell 110 may be made of a glass tube filled with rubidium atoms of atomic number 37 in a vacuum state. Rubidium atoms in the atomic vapor cell 110 may be manipulated (captured, pumped, etc.) by the coupling laser 122 and the pump laser 124 to be described later to generate two photons. At this time, the generated two photons (a photon pair) become quantum entangled with each other.

In an example embodiment, the atomic vapor cell 110 may be a glass-type cell that keeps the gas of rubidium (⁸⁷Rb) atoms warm. By using a warm atomic ensemble, the atomic vapor cell 110 of the present disclosure makes it possible to generate a more stable photon pair by a simple device compared to an atomic ensemble according to a related art.

The processor 120 generates a photon pair of a signal photon and an idler photon from the atomic vapor cell 110 by traveling the coupling laser 122 and the pump laser 124 in opposite directions with respect to the atomic vapor cell. In other words, the processor 120 is configured to include the coupling laser 11 and the pump laser 124, and may serve to generate a photon pair through manipulation by the coupling laser 122 and the pump laser 124 traveling in the opposite directions for rubidium atoms in the atomic vapor cell 110.

Here, the coupling laser 122 may be a horizontally polarized 776 nm laser, and the pump laser 124 may be a vertically polarized 780 nm laser.

Horizontal polarization may refer to polarization in a horizontal direction based on a laser traveling direction, and conversely, vertical polarization may refer to polarization in a vertical direction based on the laser traveling direction.

The coupling laser 122 and the pump laser 124 may simultaneously travel in opposite directions toward the atomic vapor cell at positions spaced apart from the atomic vapor cell at the same distance. In other words, the horizontally polarized coupling laser 122 and the vertically polarized pump laser 124 each travel in opposite directions, and reach the atomic vapor cell 110 at the same time, enabling the manipulation of rubidium atoms.

More specifically, by the horizontally polarized coupling laser 122 and the vertically polarized pump laser 124, the processor 120 may generate a photon pair in which the signal and the idler have a perpendicular polarization relationship of horizontal polarization/vertical polarization or vertical polarization/horizontal polarization. In other words, the processor 120 may cause each of photons emitted from the atomic vapor cell 110 to travel either vertically or horizontally with respect to its propagation direction according to manipulation of the coupling laser 122 and the vertically polarized pump laser 124.

Further, the coupling laser 122 and pump laser 124 may lock a laser frequency at +1 GHz outside the Doppler broadening region, in order to reduce unrelated photon pairs generated by photon resonance. In other words, the coupling laser 122 and the pump laser 124 may induce the photon pair emitted from the atomic vapor cell 110 to have the perpendicular polarization relationship of the horizontal polarization/vertical polarization or the vertical polarization/horizontal polarization by keeping the laser frequency within a prescribed range.

According to an example embodiment, the polarization-entangled quantum source 100 may detect and verify a photon pair generated in the atomic vapor cell 110.

To this end, the polarization-entangled quantum source 100 may selectively configure a prism mirror, a single photon detector, a ½λ-phase delay plate and a ¼λ-phase delay plate, and a polarizer.

The prism mirror may separate the path of the generated photon pair from the coupling laser 122 and the pump laser 124. In other words, the prism mirror may induce the photon pair generated from the atomic vapor cell 100 to travel separately from the traveling directions of the coupling laser 122 and the pump laser 124.

The single photon detector (SPD) may detect a photon pair satisfying a phase matching condition among photon pairs input along the separated path. In other words, the SPD may serve to select only a photon pair satisfying the phase matching condition, which is a condition of phases that needs to be secured between each component wave, in order to observe nonlinear characteristics of the photon pair.

The ½λ-phase delay plate (half-wave plate: HWP) and the ¼λ-phase delay plate (quarter-wave plate: QWP) may control the Bell state for the detected photon pair. In other words, the HWP and the QWP may serve to adjust the Bell state through respective phase delays for photon pairs that satisfy the phase matching condition.

The polarizer (P) may check a Bell state according to polarization for the photon pair for which the Bell state is controlled. In other words, the polarizer may serve to determine whether the Bell state is controlled to a prescribed standard state, depending on the polarization imparted to the coupling laser 122 and the pump laser 124.

By this, the polarization-entangled quantum source 100 may recognize only a photon pair whose Bell state is determined as the standard state by the polarizer as an effective photon pair to use the photon pair as a light source.

According to an example embodiment, it is possible to a robust polarization-entangled quantum source from an atomic ensemble and an implementation method of implementing a bright and powerful polarization-entangled photon pair source by utilizing strong signal-idler polarization correlation using the atomic vapor cell.

Further, according to an example embodiment, it is possible to provide a robust polarization-entangled quantum source from an atomic ensemble and an implementation method of securing frequency stability with a precision corresponding to an atomic transition line and strongly generating all four Bell states with very high stability by applying an intrinsic polarization correlation generated from a ladder-type atomic system without using an interferometric configuration.

Furthermore, according to an example embodiment, it is possible to provide a robust polarization-entangled quantum source from an atomic ensemble and an implementation method of enabling development of a polarization-entangled photon pair source with a high production rate using a low pump power.

Quantum information science is a research field including quantum communication, quantum computing, and quantum measurement, which are attracting worldwide attention, and quantum entanglement is called the heart of quantum information science.

Quantum computing and quantum measurement as well as quantum communication and quantum network all use quantum entanglement, and implementation of a high-quality quantum entanglement source is a core technology of information science applying quantum mechanics.

Quantum entanglement is a non-classical special correlation that exists between two quantum systems, and may refer to a phenomenon in which two quantum systems have a strong correlation no matter how far apart they are spatially.

Quantum transmission may refer to a transmission method that allows classical information and quantum mechanical information to be transmitted through quantum entanglement.

A representative technology of quantum entanglement source development according to a related art is to implement quantum entanglement between two photons using a nonlinear crystal. A quantum entanglement source generated according to the related art has had difficulties in storing and controlling photons because of their broad photon spectrum due to characteristics of the nonlinear crystal.

The nonlinear crystal may refer to a crystal that exhibits a response such as deformation, polarization, or magnetization that is not proportional to an external influence such as a deformation force, an electric field, or a magnetic field.

In the present disclosure, a high-efficiency polarization-entangled quantum source is proposed by controlling characteristics of the photons generated in the atomic vapor cell. Characteristics of the quantum source may be observed through quantum interference and quantum state tomography measurements.

The atomic vapor cell may refer to a medium in which pure atoms are in a vapor state by placing and sealing atoms in a high-vacuum state cell having an anti-reflection coating window through which light can travel.

In the present disclosure, a high-stability and high-quality polarization-entangled quantum source is realized in a simple experimental device using a warm atomic ensemble contained in a transparent glass tube with a length of 12 mm.

The polarization-entangled quantum source 100 of the present disclosure uses a high-density atomic vapor cell, so that the device is very simple and continuous measurement is possible.

The implementation of generation of quantum-entangled photon pairs is a science of technology that implements quantum communication, quantum computing, and quantum measurement, which are attracting worldwide attention.

Quantum entanglement is at the heart of quantum information science. Quantum entanglement is not observed in everyday life and is an interesting quantum phenomenon that, when two quantum states have a strong correlation with superposition, two quantum states are entangled no matter how far apart they are spatially.

Applications of quantum entanglement may include quantum repeater implementation which is the core of long-distance quantum communication and quantum networks, quantum computing and quantum simulator implementation using quantum entanglement between multiple quantum bits, and quantum imaging and quantum metrology implementation using quantum entanglement.

Here, the quantum repeater may refer to a quantum communication relay device that connects quantum states by using a quantum interference phenomenon without measuring the quantum states.

The quantum bit (Qbit) is a unit of quantum information and has characteristics such as fast computation speed, impossibility of replication, and irreversibility of quantum measurement.

Due to this importance, implementation of a quantum state with high-quality quantum entanglement is the most essential technology in quantum mechanics.

There are many quantum media that may implement quantum entanglement, such as photons, atoms, and superconductors.

Among them, photons may be the only quantum medium that implements quantum communication, quantum transmission, and quantum networks because photons are in a quantum state that can be transmitted rapidly at the speed of light. In addition, photons may be used in quantum metrology fields such as quantum imaging using quantum entangled photons, quantum spectroscopy, and hyperresolved imaging.

For practical implementation of quantum information technology, it is necessary to develop a quantum source with high stability and high quality quantum entanglement as well as a simple device.

A representative technology for quantum entanglement source development according to a related art is to implement quantum entanglement between two photons using a process in which a photon with a high frequency is made into a pair of photons with a low frequency using a nonlinear crystal.

A quantum entanglement source generated using the nonlinear crystal according to the related art has a broad spectrum of photons due to the characteristics of the nonlinear crystal. Photons characterized by broad spectrum may have limitations in realizing the quantum repeater and quantum memory using an atomic ensemble.

An example of recent studies to overcome these issues is to implement quantum entanglement using photons emitted from atoms.

Studies on a quantum entanglement source generated from an atomic ensemble use very slow, spatially trapped cooled atoms, mostly using laser cooling techniques.

However, a method of generating photon pairs in a cooled atomic ensemble has an issue in practical application because a complicated device is required and the stability is low.

In addition, since the atomic ensemble used in the method of generating photon pairs in the cooled atomic ensemble is in a gaseous state, the atomic ensemble moves rapidly at room temperature. However, photons emitted from the moving atomic ensemble have a limitation in their use as an effective quantum source.

An object of example embodiments is to develop a quantum source generated in an atomic ensemble with high stability and high quality quantum entanglement in a simple experimental device using a warm atomic ensemble contained in a small transparent glass material with a length of 12 mm.

Since the high-quality quantum entanglement source 100 using the warm atomic ensemble of the present disclosure uses the atomic vapor cell having a high density unlike the quantum entanglement source using the cooled atomic ensemble according to a related art, the quantum entanglement source 100 requires a very simple device and continuous measurement is possible, so it may be implemented in the form of an element.

Further, since the quantum entanglement source 100 of the present disclosure is a quantum source generated from atoms, the quantum entanglement source 100 has the advantage that optical characteristics of photons generated from independent quantum sources are the same due to the inherent properties of atoms, and may reduce the spectral width of photons to 1/1000 or less as compared to the quantum source generated from the nonlinear crystal according to the related art.

The polarization-entangled quantum source 100 using the atomic vapor cell is compact, has a simple and robust experimental device, and is economical compared to a cooled atomic system.

On the other hand, the polarization-entangled photon pair generated through the SPDC process in the nonlinear crystal is convenient and robust, and the experimental device is not complicated.

Characteristics of a polarized-entangled photon pair and an device through a SFWM process in an atomic vapor cell are similar to those of the SPDC polarized-entangled photon pair source and the device.

However, the polarized-entangled photon pair generated in the atomic vapor cell of the present disclosure has the advantage of having a narrow line width and good interaction with atoms because they are photons generated in the atomic ensemble.

The polarization-entangled photon pair source implemented by the present disclosure has a spectral brightness 105 times brighter than that of the existing one.

In addition, the photon pair source implemented using atoms for strong atom-photon interaction of the present disclosure is more efficient than the SPDC polarization-entangled photon pair source based on the nonlinear crystal.

The method of implementing a bright and strong polarization-entangled photon pair source using the strong signal-idler polarization correlation using the atomic vapor cell may secure frequency stability with a precision corresponding to the atomic transition line and strongly generate all four Bell states with very high stability by applying an intrinsic polarization correlation generated from the ladder-type atomic system without using the interferometric configuration.

Further, according to the present disclosure, there is an advantage that it is possible to develop a polarization-entangled photon pair source having a high production rate using a low pump output.

The present disclosure may implement a polarization-entangled photon pair source with a narrow linewidth that can interact with atoms using the atomic vapor cell.

The present disclosure may implement a polarization entanglement state using a unique polarization correlation generated in atoms without the interferometric configuration.

According to the present disclosure, it is possible to measure the high stability of the implemented polarization entanglement state.

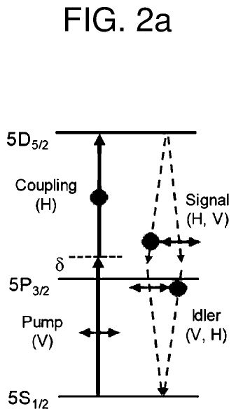

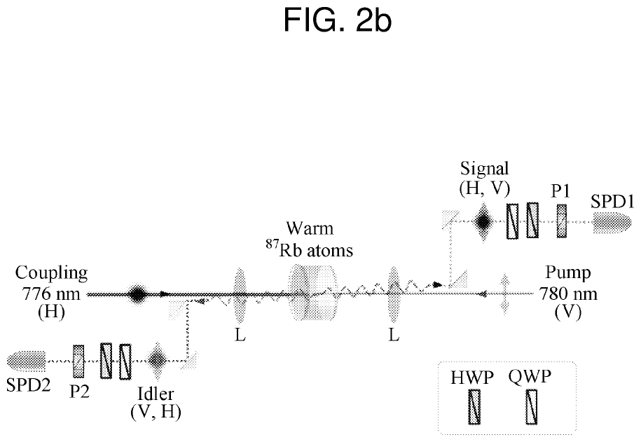

FIG. 2a and FIG. 2b is a diagram for explaining generation of sFWM in a trapezoidal atomic composition.

FIG. 2a shows an energy composition and an sFWM polarization related composition according to laser polarization.

FIG. 2b illustrates a device diagram for generating a polarization-entangled source.

Here, P is a polarizer, HWP is a ½λ-phase delay plate, QWP is a ¼λ-phase delay plate, and SPD is a single photon detector.

As shown in FIG. 2a and FIG. 2b, in a polarization-entangled quantum source of the present disclosure, a polarization-entangled photon pair may be generated by irradiating a 780 nm vertically polarized laser and a 776 nm horizontally polarized laser to a warm gas cell.

FIG. 2a shows a process of generating a polarization-entangled photon pair through sFWM in a ladder-type atomic composition.

At this time, the polarization-entangled quantum source forms a strong two-photon coherence between the 87Rb atomic ensemble 5S½-SP3/2-5D5/2 transition lines by a pump laser and a coupling laser. To reduce unrelated photons generated by unwanted single-photon resonance, the polarization-entangled quantum source may be implemented by locking the laser frequency at +1 GHz outside the Doppler broadening region.

Two photons of sFWM generated by strong two-photon coherence between the initial Zeeman sub-state and the laser-excited Zeeman sub-state generate a strong polarization correlation.

The polarization-entangled quantum source 100 of the present disclosure may obtain a photon pair having the perpendicular polarization relationship (horizontal polarization/vertical polarization or vertical polarization/horizontal polarization) by using the pump laser and the coupling laser of the horizontal polarization and the vertical polarization which are perpendicular, unlike a method of creating polarization entanglement using an interferometer according to a related art.

FIG. 2b is a device diagram for measuring experimentally implemented polarization-entangled Bell states.

The polarization-entangled quantum source 100 spatially separates the path of the photon pair and the laser using a prism mirror, and a photon pair satisfying the phase matching condition may be detected with SPD.

The polarization-entangled quantum source 100 controls the Bell state using HWP and QWP, and the Bell state according to polarization may be checked using P.

The polarization-entangled quantum source 100 of the present disclosure generates a signal-idler photon pair with quantum entanglement by traveling the coupling laser and the pump laser in opposite directions to an atomic vapor cell containing rubidium (⁸⁷Rb) atoms.

The polarization-entangled quantum source 100 may use the atomic vapor cell containing rubidium (⁸⁷Rb) atoms. The atomic vapor cell is filled with pure rubidium atomic gas in glass with a length of 12 mm and a radius of 25 mm.

The polarization-entangled quantum source 100 may use a second-order cross-correlation function to observe temporal correlation between photon pairs.

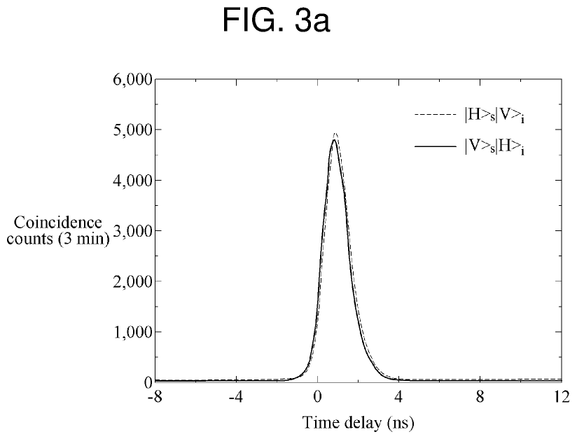

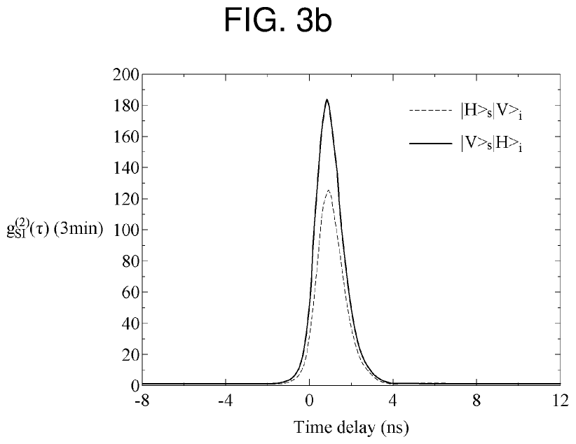

FIG. 3a and FIG. 3b is a diagram illustrating temporal statistical characteristic spectrum for two polarization entanglement modes.

In FIG. 3a, a histogram of coincidence photon counts is illustrated.

In FIG. 3b, a normalized cross-correlation function is illustrated.

FIG. 3a and FIG. 3b shows the temporal statistical characteristic for two modes/H>s/V>i, /V>s/H>i with polarization correlation.

FIG. 3a is a histogram of the coincidence counts for 180 seconds, and FIG. 3b is a spectrum obtained by normalizing an accidental coincidence count to 1.

The difference between the maximum values in FIGS. 3a and 3b is caused by different laser components scattered between the two modes.

The similarity of temporal waveforms is expressed by Formula (1).

$$\frac{{\vert \int {G}_{HV}^{( 2 )} ( τ ) {g}_{VH}^{( 2 )} ( τ ) d τ \vert}^{2}}{\int {\vert {G}_{HV}^{( 2 )} ( τ ) \vert}^{2} d τ \int {\vert {G}_{VH}^{( 2 )} ( τ ) \vert}^{2} d τ} \qquad ( 1 )$$

The indistinguishability of photon pairs is important for a high-quality quantum entanglement source. Formula (1) quantitatively expresses the identity of the temporal waveforms of two photon pairs.

The polarization-entangled quantum source 100 implemented according to the present disclosure may confirm a similarity of 99.5% between the two polarization entanglement modes.

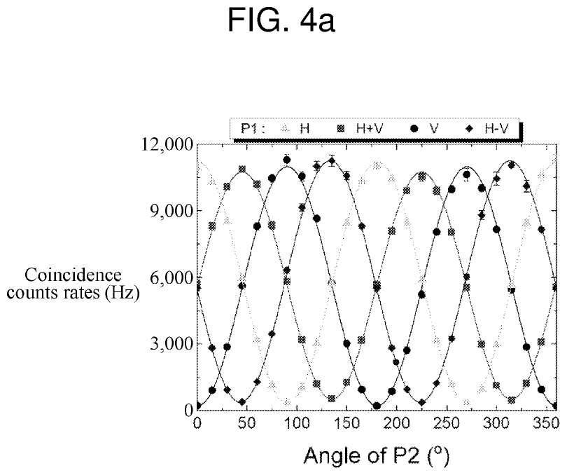

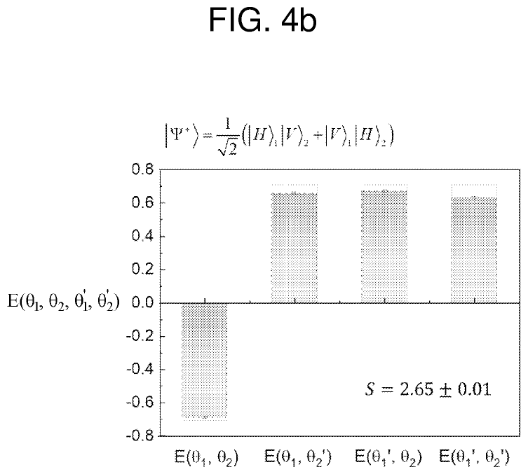

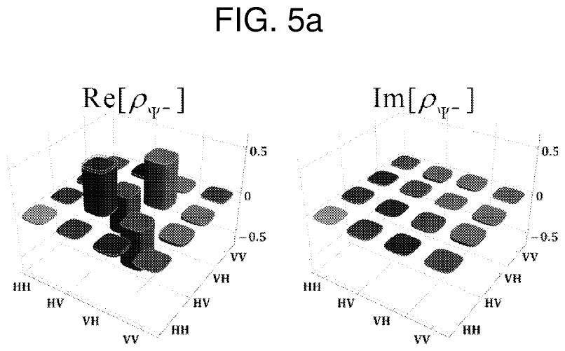

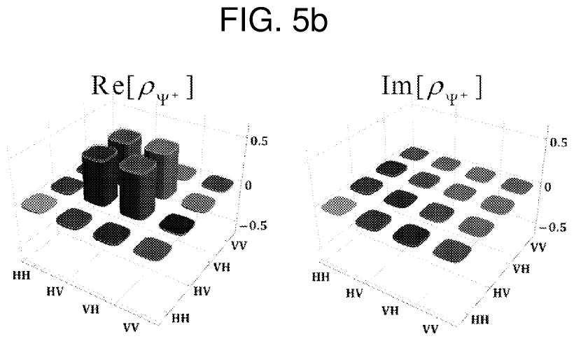

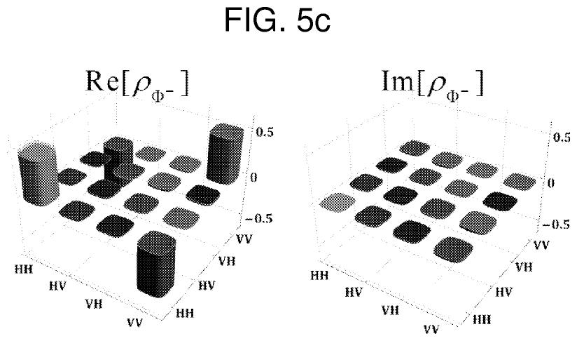

FIG. 4a and FIG. 4b is a diagram illustrating evaluation of classicality violation of /ψ⁺> which is one of the maximum entangled states (Bell states).

FIG. 4a shows interference fringes of a trigonometric function shape according to the angle of the polarizer.

FIG. 4b shows the correlation coefficient E(θ1, θ2, θ1′, θ2′) and S-parameter for measuring the degree of entanglement.

FIG. 4a and FIG. 4b is a value for checking the entanglement of /ψ⁺> made experimentally.

In FIG. 4a, in a situation where polarization projection of the signal photon is set as /H>, √(/H>+/V>), √(/H>−/V>), the polarization projection of the idler is changed to check the interference fringe. In this case, the visibility of the interference fringes may be confirmed from 93.5(2)% to 96.2(2)%.

FIG. 4b shows violation of the correlation coefficient E(θ1, θ2, θ1′, θ2′) and Clauser-Home-Shimony-Holt (CHSH) inequality for a specific polarizer combination.

In the classical case, the CHSH inequality is expressed by Formula (2).

$$S = \vert E ( {θ}_{1} , {θ}_{s} ) - E ( {θ}_{1} , {θ}_{2}^{′} ) \vert + \vert E ( {θ}_{1}^{′} , {θ}_{2} ) - E ( {θ}_{1}^{′} , {θ}_{2}^{′} ) \vert \leq 2 \qquad ( 2 )$$

Formula (2) expresses the expression for obtaining the Bell inequality S value of CHSH through the polarization entanglement correlation coefficient of the signal and idler photon pair. Here, θ₁ and θ₂ are the angles of the polarizers of the signal and idler photons, respectively. Further, θ₁′ and θ₂′ are θ₁+45° and θ₂+45°, respectively.

For an ideal entangled light source, it is known that 2√2=2.83 theoretically, and a value of S=2.65±0.01 may be confirmed for the polarization-entangled quantum source 100 of the present disclosure.

FIG. Sa to FIG. Sd is a diagram illustrating results of reconstruction of a polarization density matrix through quantum-state tomography (QST) for four Bell states. FIG. Sa shows the real part and the imaginary part of the polarization density matrix for /ψ>.

FIG. 5b shows the real part and the imaginary part of the polarization density matrix for /ψ⁺>.

FIG. 5c shows the real part and the imaginary part of the polarization density matrix for /Φ⁻>.

FIG. 5d shows the real part and the imaginary part of the polarization density matrix for /Φ⁺>.

FIG. Sa to FIG. Sd shows reconstruction of the density matrix through QST for four experimentally implemented Bell states.

FIG. 5a shows the construction when the state is /ψ⁻>, FIG. 5b shows the construction when the state is /ψ⁺>, FIG. 5c shows the construction when the state is /Φ⁻>, and FIG. 5d shows the construction when the state is /Φ⁺>.

Fidelity is the similarity between the theoretical density matrix and the experimentally implemented density matrix, and with respect to the implemented polarization-entangled quantum source 100, it may be seen that the values are 0.914(2), 0.933(1), 0.916(1), and 0.933(2), respectively.

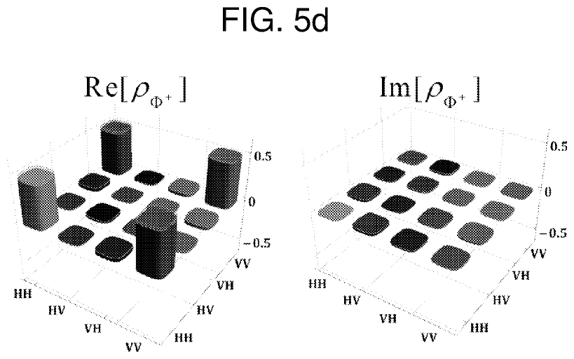

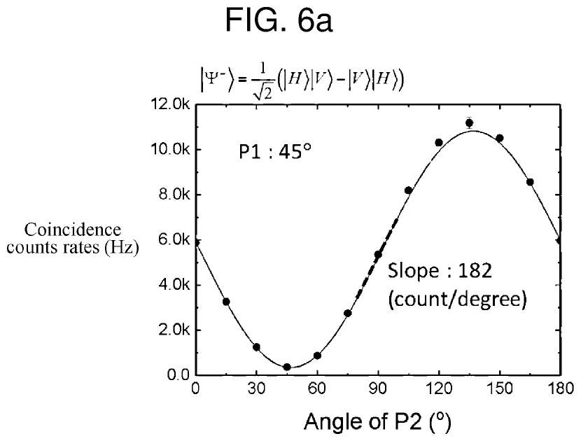

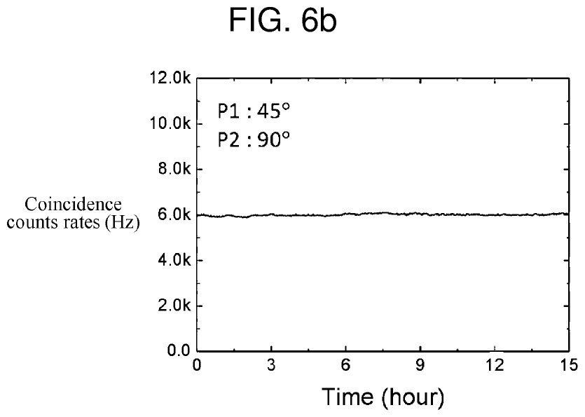

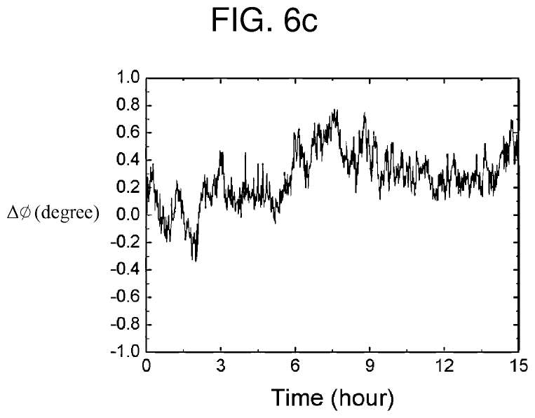

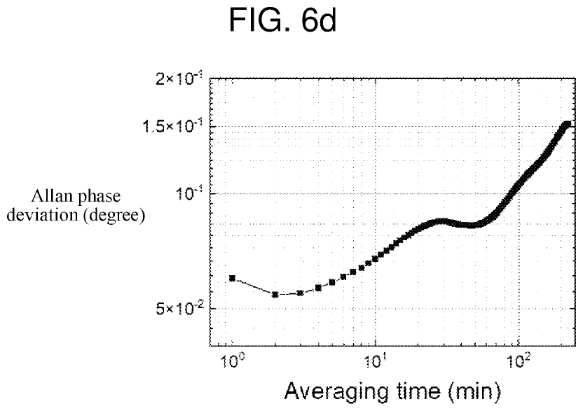

FIG. 6a to FIG. 6d is a diagram illustrating stability of a polarization-entangled photon pair.

FIG. 6a shows the interference fringe according to the P2 polarizer when the P1 polarizer in the /ψ⁻> state is 45°.

FIG. 6b shows the coincidence photon counts measured for 15 hours.

FIG. 6c shows the phase change measured for 15 hours.

FIG. 6d shows Allan phase deviation with respect to the average time.

FIG. 6a to FIG. 6d illustrates the stability for the /ψ⁻> state.

FIG. 6a shows a polarization-entangled interference fringe when the angle of the polarizer P1 is 45°, and FIG. 6b shows the coincidence counts observed for 15 hours when the angle of the polarizer P1 is 45° and the angle of the polarizer P2 is 90°.

FIG. 6c shows the coincidence counts converted to a phase difference. In this case, the angle change of the phase difference for 15 hours may be about 1º.

FIG. 6d shows that Allan deviation is obtained through the phase difference, where it can be seen that the minimum value is 0.052º at an average time of 2 minutes and it is an improved value than that of the source obtained from the traditional Sagnac interferometer.

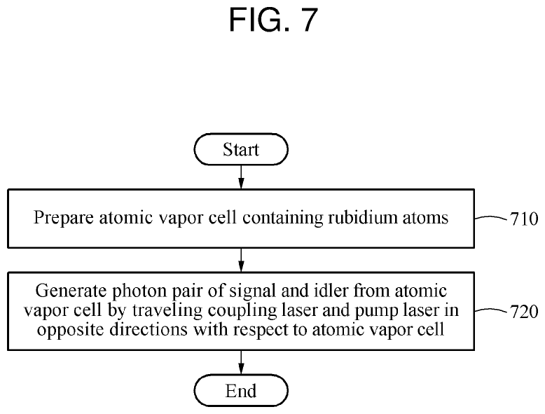

Hereinafter, a flow of implementation of the polarization-entangled quantum source 100 according to example embodiments will be described in detail with reference to FIG. 7.

FIG. 7 is a flowchart illustrating a method of implementing a robust polarization-entangled quantum source from an atomic ensemble according to an example embodiment.

First, the polarization-entangled quantum source 100 prepares an atomic vapor cell containing rubidium (⁸⁷Rb) atoms (710). The atomic vapor cell contains rubidium (⁸⁷Rb) atoms. Operation 710 may be an operation of preparing the atomic vapor cell that seals and maintains a gas of rubidium atoms.

The atomic vapor cell may be made of a glass tube filled with rubidium atoms of atomic number 37 in a vacuum state. Rubidium atoms in the atomic vapor cell may be manipulated (captured, pumped, etc.) by the coupling laser and the pump laser to generate two photons. At this time, the generated two photons (a photon pair) become quantum entangled with each other.

In one example embodiment, the atomic vapor cell may be a glass-type cell that keeps the gas of rubidium (⁸⁷Rb) atom warm. According to the use of the warm atomic ensemble, the atomic vapor cell of the present disclosure makes it possible to generate a more stable photon pair by a simple device compared to an atomic ensemble according to a related art.

In addition, the polarization-entangled quantum source 100 generates a pair of the signal and idler photons from the atomic vapor cell by traveling the coupling laser and the pump laser in opposite directions with respect to the atomic vapor cell (720). Operation 720 may be an operation of generating the photon pair through manipulation by the coupling laser and the pump laser traveling in opposite directions with respect to rubidium atoms in the atomic vapor cell.

Here, the coupling laser may be a horizontally polarized 776 nm laser, and the pump laser may be a vertically polarized 780 nm laser.

Horizontal polarization may refer to polarization in a horizontal direction based on the laser traveling direction, and conversely, vertical polarization may refer to polarization in a vertical direction based on the laser traveling direction.

The coupling laser and the pump laser may simultaneously travel in opposite directions toward the atomic vapor cell at positions spaced apart from the atomic vapor cell at the same distance. In other words, the horizontally polarized coupling laser and the vertically polarized pump laser may each travel in opposite directions, and reach the atomic vapor cell at the same time, enabling manipulation of rubidium atoms.

More specifically, the polarization-entangled quantum source 100 may generate the photon pair in which the signal and the idler have a perpendicular polarization relationship of horizontal polarization/vertical polarization or vertical polarization/horizontal polarization. In other words, the polarization-entangled quantum source 100 may allow each of the photons emitted from the atomic vapor cell to travel either vertically or horizontally with respect to the propagation direction according to the manipulation of the coupling laser and the vertically polarized pump laser.

In addition, the coupling laser and the pump lasers may lock the laser frequency at +1 GHz outside the Doppler broadening region to reduce the unrelated photon pairs produced by photon resonance. In other words, the coupling laser and the pump laser may make the laser frequency within a prescribed range so that the photon pair emitted from the atomic vapor cell is in the perpendicular polarization relationship of horizontal polarization/vertical polarization or vertical polarization/horizontal polarization.

According to an example embodiment, the polarization-entangled quantum source 100 may detect and verify the photon pair generated from the atomic vapor cell.

To this end, the polarization-entangled quantum source 100 may selectively configure a prism mirror, an SPD, an HWP and a QWP, and a polarizer.

The prism mirror may separate the path of the generated photon pair from the coupling laser and the pump laser. In other words, the prism mirror may induce the photon pair generated from the atomic vapor cell 110 to travel separately from the traveling directions of the coupling laser and the pump laser.

The SPD may detect a photon pair satisfying the phase matching condition among photon pairs input along the separated path. In other words, the SPD may serve to select only a photon pair satisfying the phase matching condition, which is a condition of phases that needs to be secured between each component wave in order to observe the nonlinear characteristics of the photon pair.

The HWP and the QWP may control the Bell state for the detected photon pair. In other words, the HWP and the QWP may serve to adjust the Bell state through respective phase delays for the photon pair satisfying the phase matching condition.

The polarizer (P) may observe the Bell state according to polarization for the photon pair for which the Bell state is controlled. In other words, the polarizer may serve to determine whether the Bell state is controlled to a prescribed standard state, depending on the polarization imparted to the coupling laser 122 and the pump laser 124.

Through this, the polarization-entangled quantum source 100 may be used as the light source by recognizing only a photon pair whose Bell state is determined as the standard state by the polarizer as an effective photon pair.

According to an example embodiment, it is possible to provide a robust polarization-entangled quantum source from an atomic ensemble and an implementation method of implementing a bright and powerful polarization-entangled photon pair source by utilizing strong signal-idler polarization correlation using the atomic vapor cell.

Further, according to an example embodiment, it is possible to provide a robust polarization-entangled quantum source from an atomic ensemble and an implementation method of securing frequency stability with a precision corresponding to the atomic transition line and strongly generating all four Bell states with very high stability by applying the intrinsic polarization correlation generated from the ladder-type atomic system without using the interferometrie configuration.

Furthermore, according to an example embodiment, it is possible to provide a robust polarization-entangled quantum source from an atomic ensemble and an implementation method of enabling development of a polarization-entangled photon pair source with a high production rate using a low pump power.

The methods according to example embodiments may be embodied as program instructions that are executable by various computer means and recorded on a non-transitory computer-readable medium. The non-transitory computer-readable medium may include program instructions, data files, data structures, and the like alone or in combination. The program instructions recorded on the medium may be specially designed and configured for example embodiment, or may be known and available to those skilled in the art of computer software. Examples of the computer-readable recording medium include hardware devices specially configured to store and execute program instructions, such as magnetic media such as hard disks, floppy disks, and magnetic tapes, optical media such as CD-ROMs and DVDs, magneto-optical media such as floptical disks. ROM, RAM, and flash memory. Examples of the program instructions include not only machine language codes such as those generated by a compiler, but also high-level language codes that are executable by a computer using an interpreter or the like. The hardware devices described above may be configured to operate as one or more software modules to perform the operations of the example embodiments, and vice versa.

Software may comprise a computer program, code, instructions, or a combination of one or more thereof, which may configure a processor to operate as desired or independently or collectively instruct the processor. Software and/or data may be permanently or temporarily embodied in any kind of machine, component, physical device, virtual equipment, computer storage medium or device, or a transmitted signal wave to be interpreted by or to provide instructions or data to the processor. Software may be distributed over networked computer systems and stored or executed in a distributed manner. Software and data may be stored in one or more non-transitory computer-readable recording media.

As described above, although the example embodiments have been described with reference to the limited drawings, those skilled in the art may apply various technical modifications and variations based on the above descriptions. For example, the described techniques may achieve an appropriate result even if they are performed in an order different from the described methods, and/or the described components of the system, structure, device, circuit, and the like are combined or connected in a different form than the described methods or substituted or replaced by other components or equivalents.

Therefore, other implementations, other example embodiments, and equivalents to the claims also fall within the scope of the following claims.

1. A robust polarization-entangled quantum source from an atomic ensemble comprising:
an atomic vapor cell containing rubidium (⁸⁷Rb) atoms; and
a processor configured to generate a photon pair of a signal and an idler from the atomic vapor cell by traveling a coupling laser and a pump laser in opposite directions with respect to the atomic vapor cell.

2. The robust polarization-entangled quantum source of claim 1, wherein the coupling laser is a horizontally polarized 776 nanometer (nm) laser,
the pump laser is a vertically polarized 780 nm laser, and
the coupling laser and the pump laser simultaneously travel in opposite directions toward the atomic vapor cell at positions spaced apart from the atomic vapor cell at the same distance.

3. The robust polarization-entangled quantum source of claim 2, wherein the processor generates the photon pair in which the signal and the idler have a perpendicular polarization relationship of horizontal polarization/vertical polarization or vertical polarization/horizontal polarization by the horizontally polarized coupling laser and the vertically polarized pump laser.

4. The robust polarization-entangled quantum source of claim 2, wherein the coupling laser and the pump laser lock a laser frequency at +1 gigahertz (GHz) outside a Doppler broadening region to reduce unrelated photon pairs generated by photon resonance.

5. The robust polarization-entangled quantum source of claim 1, wherein the atomic vapor cell is a glass-type cell configured to keep a gas of the rubidium (⁸⁷Rb) atoms warm.

6. The robust polarization-entangled quantum source of claim 1, further comprising:
a prism mirror configured to separate a path of the generated photon pair from the coupling laser and the pump laser;
a single photon detector (SPD) configured to detect a photon pair satisfying a phase matching condition among the photon pairs input along the separated path;
a ½λ-phase delay plate (half-wave plate: HWP) and a ¼λ-phase delay plate (quarter-wave plate: QWP) configured to control a Bell state for the detected photon pair; and
a polarizer (P) configured to observe the Bell state according to polarization for the photon pair for which the Bell state is controlled.

7. An implementation method of a robust polarization-entangled quantum source from an atomic ensemble, the method comprising:
preparing an atomic vapor cell containing rubidium (⁸⁷Rb) atoms; and
generating a photon pair of a signal and an idler from the atomic vapor cell by traveling a coupling laser and a pump laser in opposite directions with respect to the atomic vapor cell.

8. The method of claim 7, wherein the coupling laser is a horizontally polarized 776 nm laser,
the pump laser is a vertically polarized 780 nm laser, and
the coupling laser and the pump laser simultaneously travel in opposite directions toward the atomic vapor cell at positions spaced apart from the atomic vapor cell at the same distance.

9. The method of claim 8, wherein the generating of the photon pair comprises generating the photon pair in which the signal and the idler have a perpendicular polarization relationship of horizontal polarization/vertical polarization or vertical polarization/horizontal polarization by the horizontally polarized coupling laser and the vertically polarized pump laser.

10. The method of claim 8, wherein the coupling laser and the pump laser lock a laser frequency at +1 GHz outside a Doppler broadening region to reduce unrelated photon pairs generated by photon resonance.

11. The method of claim 7, wherein the preparing of the atomic vapor cell comprises preparing a glass-type cell configured to keep a gas of the rubidium (⁸⁷Rb) atoms warm.

12. The method of claim 7, further comprising:
at a prism mirror, separating a path of the generated photon pair from the coupling laser and the pump laser;
at a single photon detector (SPD), detecting a photon pair satisfying a phase matching condition among the photon pairs input along the separated path;
at a ½λ-phase delay plate (half-wave plate: HWP) and a ¼λ-phase delay plate (quarter-wave plate: QWP), controlling a Bell state for the detected photon pair; and
at a polarizer (P), observing the Bell state according to polarization for the photon pair for which the Bell state is controlled.

13. A non-transitory computer-readable recording medium on which a program for executing the method of claim 7 is recorded.
